(19) United States
(12) Patent Application Publication
(10) Pub. No.: US 2010/0082917 A1
(43) Pub. Date: Apr. 1, 2010

(54) SOLID STATE STORAGE SYSTEM AND METHOD OF CONTROLLING SOLID STATE STORAGE SYSTEM USING A MULTI-PLANE METHOD AND AN INTERLEAVING METHOD

(76) Inventors: Wun-Mo YANG, Ichon-si (KR); Jeong-Soon KWAK, Ichon-si (KR)

Correspondence Address: LADAS & PARRY LLP, 224 SOUTH MICHIGAN AVENUE, SUITE 1600, CHICAGO, IL, 60604, US

(21) Appl. No.: 12/344,665

(22) Filed: Dec. 29, 2008

(30) Foreign Application Priority Data
Oct. 1, 2008 (KR) 10-2008-0096739

(51) Int. Cl. G06F 12/02; G06F 12/00

(52) U.S. Cl. 711/157; 711/154; 711/E12.007; 711/E12.001

(57) ABSTRACT

A solid state storage system includes a memory area configured to include a plurality of chips, and a micro controller unit (MCU) configured to perform a control operation, such that continuous logical block addresses are allocated using a multi-plane method or an interleaving method to different chips, and a read/write operation is performed in the logical block address unit in response to a read/write command.

### CROSS-REFERENCES TO RELATED PATENT APPLICATION

The present application claims priority under 35 U.S.C 119(a) to Korean Patent Application No. 10-2008-0096739, filed on Oct. 1, 2008, in the Korean Intellectual Property Office, which is incorporated herein by reference in its entirety as set forth in full.

### BACKGROUND

The present invention relates generally to a solid state storage system and a method of controlling the solid state storage system, and more particularly to a solid state storage system capable of controlling allocation of memory blocks and a method of controlling the solid state storage system.

In recent years, in order to improve write performance of solid state storage systems, such as solid state drives (SSD) using NAND flash memories, a multi-plane method and an inter-chip interleaving method have been used. The multi-plane method utilizes a plurality of planes included in the same chip for an operation, and the inter-chip interleaving method utilizes different chips for an operation. That is, in the multi-plane method and the interleaving method, addresses are allocated and controlled such that continuous memory storage areas are not concentrated on the same plane but are uniformly distributed to a plurality of planes or chips, thereby improving access speed to a host. Accordingly, in order to use two operation modes that are based on the multi-plane method and the inter-chip interleaving method, predetermined page units or blocks are grouped to generate virtual pages or virtual blocks, such that the operation is controlled in a virtual page unit or a virtual block unit.

However, as is well known, due to the characteristics of a flash memory, in order to update data in a storage area after the data is written, new data needs to be written after the data stored in the selected data storage area is erased. For this reason, when a handling unit of data is large but the size of the data to be actually processed is small, then read, write, and merge processes may be repeatedly performed even in an extra area in a virtual block (or virtual page) where data is not stored. Accordingly, there are cells in which the frequency of updating data increases even whether or not data is already stored, and as such aging of the cells is accelerated. As a result, the lifespan of the SSD may be rapidly shortened.

### SUMMARY

A solid state storage system that capable of controlling equal utilization of blocks is disclosed herein.

A method of controlling a solid state storage system that capable of controlling equal utilization of blocks is disclosed herein.

In one embodiment of the present invention, a solid state storage system includes a memory area configured to include a plurality of chips; and a micro controller unit (MCU) configured to perform a control operation, such that continuous logical block addresses are allocated to the different chips, and a read/write operation is performed in the logical block address unit in response to a read/write command.

In another embodiment of the present invention, a solid state storage system includes a first chip configured to include a plurality of planes; a second chip configured to include a plurality of planes; and a micro controller unit (MCU) configured to allow continuous logical block addresses to be mapped to different chips, while one logical block address is allocated to the plurality of planes in the same chip. The logical block addresses define a basic unit that is used when a read/write operation is performed.

In yet another embodiment of the present invention, a solid state storage system includes a micro controller unit (MCU) configured to control a read/write operation in a virtual page unit; and a memory area configured to be controlled by the MCU such that data of two units or more on the basis of the virtual page unit is processed after the data is distributed to different chips.

In another embodiment of the present invention, a method of controlling a solid state storage system includes generating logical block addresses in a virtual page unit; allocating the continuous logical block addresses to different chips; and processing data using an inter-chip interleaving method or a multi-plane method according to a size of the data, when the data is processed in response to a command from an external host.

According to an embodiment of the present invention, in order to uniformly manage the lifespan of memory areas, a virtual page unit is defined as a predetermined unit that can be processed in the same chip. Accordingly, logical block addresses that are allocated in the virtual page unit are mapped to be allocated to different chips. As a result, since data having a small size is processed in only the same chip, a size of an unnecessary updated cell area can decrease. Further, when data has a large size, the data is processed in different chips but each data process is performed in the same chip in the virtual page unit, thus, data can be easily controlled. Accordingly, it is possible to efficiently manage the lifespan of each memory cell.

These and other features, aspects, and embodiments are described hereinbelow in the section “Detailed Description.”

### BRIEF DESCRIPTION OF THE DRAWINGS

Features, aspects, and embodiments are described in conjunction with the attached drawings, in which:

FIG. 1 is a block diagram of an exemplary solid state storage system according to an embodiment of the present invention;

FIG. 2 is a block diagram of a hierarchical structure of an exemplary memory area that can be included with the system according to an embodiment of the present invention;

FIG. 3 is a conceptual block diagram of a logical block address mapping relationship according to an embodiment of the present invention; and

FIG. 4 is a flowchart shown for illustrating a method of controlling a solid state storage system according to an embodiment of the present invention.

### DETAILED DESCRIPTION

Hereinafter, a solid state storage system and a method of controlling the solid state storage system according to an embodiment of the present invention will be described with reference to the accompanying drawings.

Each block of the block diagrams may represent a module, segment, or portion of code, which includes one or more executable instructions for implementing the specified logical function(s). It should also be noted that in some alternative implementations, the functions noted in the blocks may occur out of order. For example, two blocks shown in succession may in fact be substantially executed concurrently or the blocks may sometimes be executed in an alternate order depending upon the functionality involved.

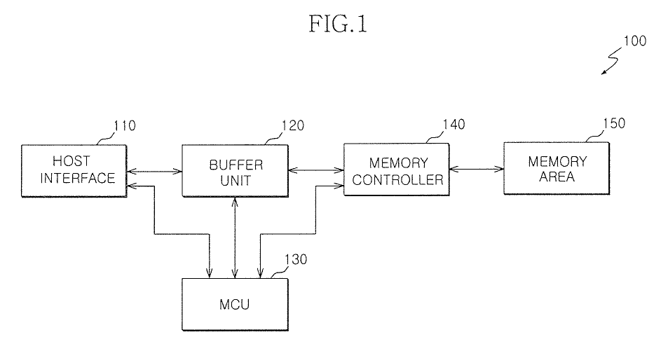

First, a solid state storage system according to an embodiment of the present invention will be described with reference to FIGS. 1 to 3.

FIG. 1 is a block diagram of an exemplary solid state storage system 100 according to an embodiment of the present invention. In this case, the solid state storage system 100 is exemplified as a storage system using a NAND flash memory.

Referring to FIG. 1, the solid state storage system 100 may include a host interface 110, a buffer unit 120, a micro controller unit (MCU) 130, a memory controller 140, and a memory area 150.

First, the host interface 110 can be connected to the buffer unit 120, and the host interface 110 can transmit and receive control commands, address signals, and data signals between an external host (not shown) and the buffer unit 120. An interface method between the host interface 110 and the external host (not shown) may be any one of a serial advanced technology attachment (SATA) method, a parallel advanced technology attachment (PATA) method, an SCSI method, a method using an express card, a PCI-Express method, and the like. It should be understood that the above interface methods are only exemplary and are not exclusive.

The buffer unit 120 can buffer output signals from the host interface 110 or store mapping information between logical addresses and physical addresses. In the present embodiment the buffer unit 120 can use a static random access memory (SRAM).

The MCU 130 can exchange control commands, address signals, and data signals with the host interface 110 or control the memory controller 140 using the above signals.

According to one embodiment of the present invention, the MCU 130 can allocate continuous logical block addresses to different chips using a flash translation layer (FTL) conversion, and the MCU 130 can perform a control operation such that a read/write operation is performed in a logical block address unit in response to a read/write command. The logical block address can be used as a virtual page unit that includes sector addresses of the number equal to the number of planes included in the same chip on the basis of a corresponding chip. That is, the logical block address can be obtained by grouping sector addresses allocated to different planes on the basis of the same chip. According to the present embodiment, the MCU 130 can generate the logical block addresses by grouping the sectors addresses in a predetermined unit and the MCU can both distribute and map the logical block addresses to the chips of the entire memory area. As a result, a control operation can be performed such that the continuous logical block address groups are sequentially mapped to physical blocks of the different chips.

According to the present embodiment, the memory controller 140 can select a predetermined NAND flash memory element ND from a plurality of NAND flash memory elements of the memory area 150. The memory controller can also provide any of a program command, an erase command, and a read command to the selected NAND flash memory element. The memory controller 140 can be controlled by a mapping method of the MCU 130, and perform a control operation, such that continuously received large unit data can be distributed and processed in the plurality of chips in the memory area 150 in accordance with an interleaving method.

Specifically, continuous large unit (bulk unit) data can be distributed and stored in substantially all planes by the logical block addresses that are distributed and mapped such that pages are designated in different planes. Thus, a specific plane where a program frequency is low and large unit data is concentrated can be prevented from being generated. In this case, it is assumed that the large unit data is data exceeding a virtual page unit and the bulk unit data is data having a size of 2 Mbytes or more. With respect to data having a small size, for example, a size of 512 Kbytes, the operation can be performed in a virtual page unit of a selected chip.

As such, according to one embodiment, address mapping is performed using distribution mapping and a handling unit of a data area is decreased. As a result, both a multi-plane method and an interleaving method can be used. That is, when an operation is performed on relatively small unit data, the operation can be performed in accordance with the multi-plane method, and when an operation is performed on large unit data having a size in the Mbyte range, the operation can be performed in accordance with the interleaving method, which will be described in detail below.

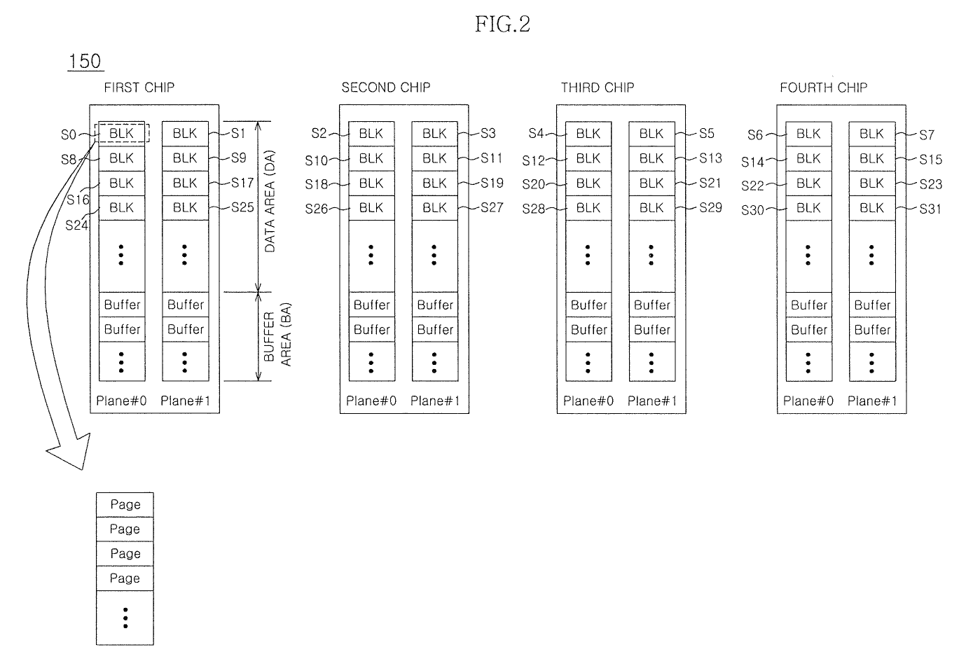

The memory area 150 may be controlled by the memory controller 140 and data programming, erase, and read operations can be performed in the memory area 150. In particular, the memory area 150 can be controlled by the logical block addresses that are distributed and mapped by the MCU 130. Through this, data can be uniformly distributed and stored in all of the planes. According to an embodiment of the present invention, the memory area 150 may be, for example, a NAND flash memory. For convenience of explanation, the memory area 150, as shown in FIG. 2, is exemplified as one NAND flash memory, though it is understood that the memory area 150 may include a plurality of NAND flash memories.

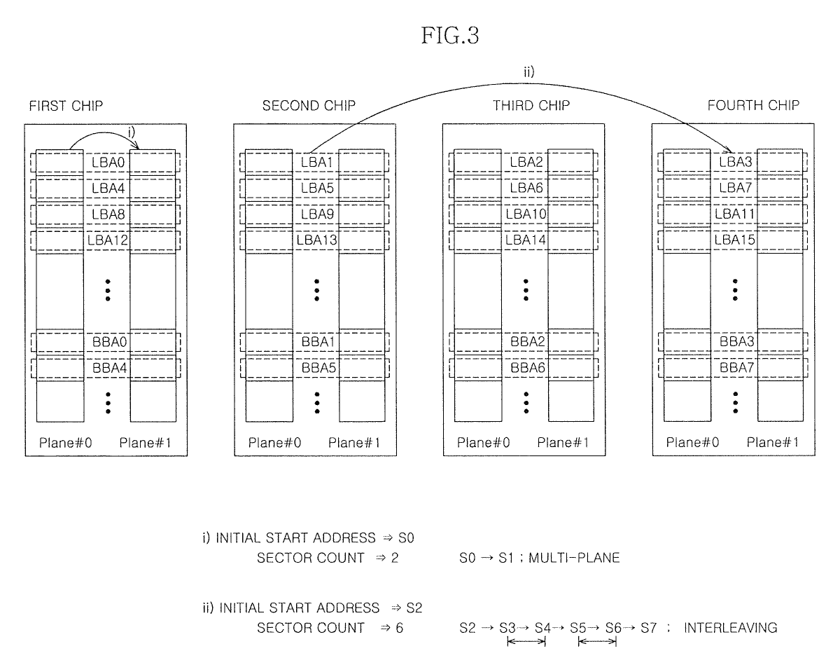

FIG. 2 is a block diagram of a hierarchical structure of an exemplary memory area 150 of a system, such as the system shown in FIG. 1, according to an embodiment of the present invention. FIG. 3 is a conceptual block diagram of a logical block address mapping relationship according to an embodiment of the present invention.

Referring to FIGS. 2 and 3, the memory area 150 includes a plurality of chips first chip, second chip, third chip, fourth chip. Though FIGS. 2 and 3 show the memory area 150 as including four chips, it is to be understood that the four chips are shown to aid in the description of embodiments of the present invention, and as such, any number of chips may be included in the memory area 150 according to the present invention.

As shown in FIGS. 2 and 3, each of the chips includes a plurality of planes plane #0, plane #1. While two planes plane #0, plane #1 are shown in FIGS. 2 and 3, it is to be understood that any number of planes are considered according to the present invention. Each of the planes plane #0, plane #1 may include a plurality of memory blocks BLK, and each of the memory blocks BLK can be configured to include a plurality of pages that are grouped on the basis of shared word lines.

As is well known, each of the planes plane #0, plane #1 can be configured to include a main block that is allocated by a predetermined area including available blocks BLK and a spare block having an arbitrary storage block. In this case, the main block can be called a data area (DA) and the spare block can be called a buffer area (BA).

The block BLK is further described hereinbelow. As shown in FIG. 2, each of the blocks BLK has an arbitrarily set sector addresses S0˜S31 respectively. For convenience of explanation, the sector addresses S0˜S31 are shown, but are only exemplary, and as such the present invention is not limited to the number of sector addresses shown in FIG. 2.

The continuous sector addresses S0˜S31 can be allocated to the different planes plane #0, plane #1. Additionally, the continuous sector addresses S0˜S31 in the same chip (e.g., S0, S1 in the first chip; S2,S3 in the second chip) are grouped. As shown in FIG. 3, as it relates to FIG. 2, logical block addresses LBA0˜LBA15 in the virtual page unit can be allocated to the grouped sector addresses. Further, buffers in the buffer area (BA) of each chip that correspond to the logical block addresses LBA0˜LBA15 can be grouped and buffer addresses BBA0˜BBA7 can be allocated to the buffers. It should be understood that the number of logical block addresses and buffer addresses is not limited to the number of such addresses shown in FIGS. 2 and 3.

Specifically, when the selected logical block address is ‘LBA0’, only a buffer that is included in the same chip can be allocated as a buffer that corresponds to the selected logical address. In this case, a buffer that corresponds to an arbitrary buffer address ‘BBA0’ or ‘BBA4’ can be allocated among a plurality of buffers that are included in the first chip. Accordingly, data corresponding to the selected logical block address ‘LBA0’ can be processed using buffers that are included in the same chip. Through this, wear leveling can be performed for every chip.

The continuous logical block addresses LBA0˜LBA15 can be allocated to different chips, respectively, on the basis of the logical block addresses LBA0˜LBA15. Accordingly, when the solid state storage system is operated in accordance with an external command, both the multi-plane method and the interleaving method can be used.

That is, a logical block address 0 ‘LBA0’ can be used to map a physical block that has continuous sector addresses ‘S0 and S1’ in the first and second planes ‘plane #0 and plane #1’ of the first chip. On the basis of the above relationship, if a logical block address is known, it is possible to calculate a selected physical block using sector addresses. An allocation rule of sector addresses in the same plane can be defined by a rule of a+(n−1)d (where ‘a’ is a starting address as a positive integer type, ‘n’ is a natural number, and ‘d’ is the total number of planes).

As such, according to an embodiment of the present invention the logical block addresses LBA0˜LBA15 are allocated in a virtual page unit, and the read/write operation are performed in the virtual page unit in accordance with an external command.

Specifically, when a write command is requested from the outside (i.e., externally), a write operation can be performed in a virtual page unit in accordance with a mapping method according to an embodiment of the present invention. Arbitrary buffer blocks in a chip where physical blocks corresponding to the selected logical block addresses LBA0˜LBA15 exist can be calculated as the buffer blocks that correspond to the selected logical block addresses LBA0˜LBA15.

As described above, since a flash memory is a non-volatile memory, another data cannot be overwritten in a page where data is already written. That is, new data can be written in the corresponding page only when the written data is first erased. Accordingly, in order to update data, both write and erase processes are required.

According to the present invention, when a virtual page unit, where a write operation is performed to support both the inter-chip interleaving method and the multi-plane method, is generated to have a large size, if data having a small size is continuously updated, aging of a device is accelerated due to an updating process on a corresponding virtual page.

However, according to one embodiment of the present invention, the logical block addresses may be allocated to be uniformly distributed to all of the chips, and the sector addresses S0˜S31 may be grouped within each chip, on the basis of the number of planes, thereby forming a virtual page unit.

As a result, with respect to data having a small size, the operation can be performed in one virtual page unit. Since a virtual page includes one or more different planes included in the same chip, the multi-plane method can be used.

However, when data has a large size, a plurality of virtual pages are needed. Therefore, according to an embodiment the present invention, the interleaving method can be used when the data has a large size because memory areas that are distributed to the plurality of chips are allocated as described above.

Referring to FIG. 3, (i) denotes a case where an initial start sector address is S0 and data within a virtual page unit is written. According to (i), the MCU 130 can determine a sector count corresponding to the number of planes in a chip as 2 (i.e. this case which data size is within virtual page unit). Accordingly, a write operation is performed sequentially on a maximum of two sectors including the initial start sector address S0. In this case, since the operation is performed in different planes in only the first chip, the multi-plane method can be used.

Still referring to FIG. 3, (ii) denotes a case where an initial start sector address is S2 and data exceeding a virtual page unit is written. In this case, since data cannot be processed in a virtual page unit, the MCU 130 can determine the size of data and set a sector count corresponding to the size of the data(i.e. this case which data size is excess over than virtual page unit). In the present embodiment, for example, the sector count is set as 6. Accordingly, a write operation is sequentially performed on a maximum of 6 sectors, based on the sector count set corresponding to the size of the data, including the initial start sector address S2. In this case, since physical areas where the operation is performed in different chips are generated (e.g., an area between S3 and S4 and an area between S5 and S6), the interleaving method can be used.

Accordingly, the present invention overcomes deficiencies associated with the conventional art as described above. That is, in the conventional art, since a virtual page unit is configured to include all physical areas, even though there are two sectors where data having a small size is actually written, all physical areas in a selected page need to be read and erased when new data is updated. As a result, the lifespan of cells in extra sectors is shortened due to the unnecessary use of the cells.

However, according to an embodiment of the present invention, the lifespan management of blocks can be efficiently performed by controlling a handling unit of data to be small, while the multi-plane method and the interleaving method are satisfied.

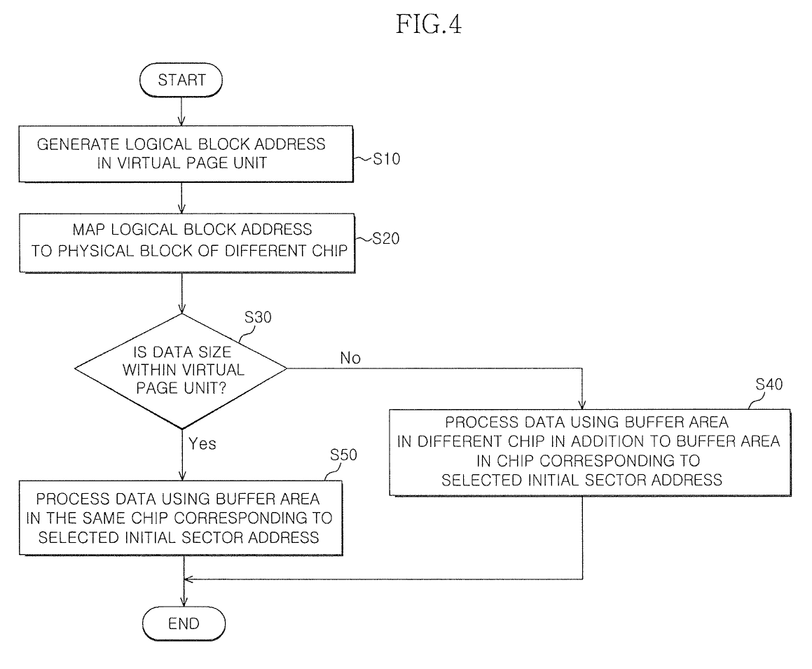

FIG. 4 is a flowchart shown for illustrating a method of controlling a solid state storage system according to an embodiment of the present invention.

The method of controlling a solid state storage system will be described with reference to FIGS. 1 to 4.

The logical block addresses LBA0˜LBA15 in a virtual page unit are generated (step S10).

First, the sector addresses S0˜S31 are allocated to the individual blocks in the chips, while the continuous sector addresses S0˜31 are allocated to the different planes. At this time, the continuous sector addresses in the same chip are grouped, thereby generating the logical block addresses LBA0˜LBA15 that correspond to one virtual page unit.

The generated logical block addresses LBA0˜LBA15 are mapped to the physical blocks of the different chips (step S20).

Specifically, the continuous logical block addresses LBA0˜LBA15 are mapped to the different chips. When the logical addresses and the physical addresses are mapped to each other such that data is distributed and arranged using the logical addresses, uniform distribution mapping is performed with respect to all of the planes.

The memory controller 140 can process data in a memory area according to a mapping method of logical block addresses in response to a command from the external host. At this time, it is determined whether a data size is a size within a virtual page unit (step S30).

When the data size within the virtual page unit (Yes), data is read or written using a buffer area (BA) in the same chip that corresponds to the selected initial sector addresses S0˜S31 (step S50). Then, wear leveling of physical areas that correspond to the logical block addresses LBA0˜LBA15 can be performed within the corresponding buffer area. As a result, since a handling unit of data decreases, it is possible to efficiently manage the lifespan of cells.

When the data size exceeds the virtual page unit (No), data is read or written using a buffer area (BA) of a different chip in addition to the buffer area of the chip that corresponds to the selected initial sector addresses S0˜S31. It should be understood that the corresponding method is an interleaving method in which the operation is performed in different chips in terms of the solid state storage system, and the operation is performed in the virtual page unit in terms of each chip. As described above, wear leveling, such as an erase period management, can be performed using a buffer area (BA) in each chip.

As such, according to an embodiment of the present invention, the logical block addresses using the sector addresses can be allocated to the different chips, such that both the interleaving method and the multi-plane method that correspond to a data operation control method can be performed. Further, a read/write operation unit of data is controlled to become a virtual page unit having a small size. As a result, according to the present invention the lifespan of cells is efficiently managed.

While certain embodiments have been described above, it is to be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A solid state storage system, comprising:
a memory area configured to include a plurality of chips; and
a micro controller unit (MCU) configured to perform a control operation, such that continuous logical block addresses are allocated to different chips among a plurality of chips, and a read/write operation is performed in a logical block address unit in response to a read/write command.

2. The solid state storage system of claim 1,
wherein each of the chips among the plurality of chips is configured to include a plurality of planes, each plane including a plurality of physical blocks and sector addresses are allocated to the plurality of physical blocks, respectively, and
the MCU is configured to allocate the continuous sector addresses to different planes among the plurality of planes.

3. The solid state storage system of claim 2, wherein the MCU is configured to group a number of the sector addresses and generate the logical block addresses, the number of the sector addresses being equal to the number of planes in each chip.

4. The solid state storage system of claim 2, wherein the MCU is configured to allocate the sector addresses in a same plane according to a rule of a+(n−1)d, where ‘a’ is a starting address as a positive integer type, n is a natural number, and d is the total number of planes.

5. A solid state storage system, comprising:
a first chip configured to include a plurality of planes;
a second chip configured to include a plurality of planes; and
a micro controller unit (MCU) configured map continuous logical block addresses to different chips, wherein one logical block address is allocated to the plurality of planes in a same chip,
wherein the logical block addresses define a basic unit that is used when a read/write operation is performed.

6. The solid state storage system of claim 5, wherein each of the planes is configured to include a plurality of blocks and sector addresses are allocated to the plurality of blocks, respectively.

7. The solid state storage system of claim 6, wherein the MCU is configured to allocate the sector addresses in a same plane according to a rule of a+(n−1)d where a is a positive integer, n is a natural number, and d is the total number of planes.

8. The solid state storage system of claim 7, wherein the MCU is configured to allocate the continuous sector addresses to different planes among the plurality of planes.

9. The solid state storage system of claim 7, wherein the MCU is configured to group the continuous sector addresses in the same plane and generate the logical block addresses.

10. A solid state storage system, comprising:
a micro controller unit (MCU) configured to control a read/write operation in a virtual page unit; and
a memory area configured to be controlled by the MCU such that data of two or more units on the basis of the virtual page unit is processed after the data is distributed to different chips.

11. The solid state storage system of claim 10, wherein the MCU is configured to selectively use an inter-chip interleaving method or a multi-plane method according to a data size.

12. The solid state storage system of claim 11, wherein the MCU is configured to perform a control operation such that the different chips are allocated using continuous logical block addresses so as to support the inter-chip interleaving method and the multi-plane method.

13. The solid state storage system of claim 12, wherein the memory area is configured such that data requested to be processed in accordance with an external command is processed using different planes in the same chip, when the size of the data is within the virtual page unit.

14. The solid state storage system of claim 12, wherein the memory area is configured such that data requested to be processed in accordance with an external command is processed using planes in the different chip, when a size of the data exceeds the virtual page unit.

15. A method of controlling a solid state storage system, comprising:
generating logical block addresses in a virtual page unit;
allocating continuous logical block addresses among the logical block addresses to different chips among a plurality of chips; and
processing data using an inter-chip interleaving method or a multi-plane method according to a size of the data, when the data is processed in response to a command from an external host.

16. The method of claim 15, further comprising:
when each of the plurality of chips is configured to include a plurality of planes and each of the planes is configured to include a plurality of blocks,
before the generating of the logical block addresses,
allocating a sector address to each of the blocks included in the plurality of chips, while the continuous sector addresses are allocated to the different planes.

17. The method of claim 16, wherein, in the generating of the logical block addresses, a number of the sector addresses in a chip are grouped, the number of sector addresses being equal to the number of planes in the chip.

18. The method of claim 15, wherein, in the allocating of the continuous logical block addresses, mapping is performed such that physical blocks mapped using the continuous logical block addresses become physical blocks of the different chips, so as to control distribution arrangement of data.

19. The method of claim 15,
wherein, when the data size is within the virtual page unit, a control operation is performed such that the data is processed using different planes in the same chip, so as to support a multi-plane method, and
when the data size exceeds the virtual page unit, a control operation is performed such that the data is processed using the planes of different chips, so as to support an interleaving method.
